(19) United States
(12) Patent Application Publication
(10) Pub. No.: US 2016/0107346 A1
(43) Pub. Date: Apr. 21, 2016

(54) STIFFENER FOR INSERT MOLDING AND MANUFACTURING METHOD OF CRASH PAD USING THE SAME

(71) Applicants: Hyundai Mobis Co., Ltd., Seoul (KR); MDB Mold Co., Ltd., Hwaseong-si (KR)

(72) Inventors: Byung Young KANG, Yongin-si (KR); Young Suk JEON, Hwaseong-si (KR)

(21) Appl. No.: 14/817,948

(22) Filed: Aug. 4, 2015

(30) Foreign Application Priority Data
Oct. 15, 2014 (KR) 10-2014-0139302

(51) Int. Cl. B29C 45/14; B29C 44/14; B29C 44/12; B29C 45/00

(52) U.S. Cl. CPC B29C 45/14065; B29C 45/0001; B29C 45/14631; B29C 45/14819; B29C 44/146; B29C 44/1266; B29K 2305/12

(57) ABSTRACT

A stiffener for insert-molding including a stiffening bar for insert-molding and insert setting members provided on an outer periphery of the stiffening bar at a predetermined interval. Durability of a crash pad can be significantly improved by insert-molding the stiffener during the manufacturing process of the crash pad. Manufacturing the crash pad includes setting a skin on a lower mold, setting the stiffener that matches a skin corner at the skin corner while the skin is set on the lower mold, and injecting a foam liquid between the skin set on the lower mold and a core set on an upper mold while the stiffener is set at the skin corner.

### CROSS-REFERENCE TO RELATED APPLICATION

This application claims priority from and the benefit of Korean Patent Application No. 10-2014-0139302 filed on Oct. 15, 2014, which is hereby incorporated by reference for all purposes as if fully set forth herein.

### BACKGROUND

1. Field

Exemplary embodiments relate to a stiffener for insert-molding that can improve durability by insert-molding a stiffener and facilitate a molding operation by restricting a position of the stiffener at the time of insert-molding the stiffener, and a manufacturing method of a crash pad using the same.

2. Discussion of the Background

In general, a crash pad is deployed at front portions of a driver's seat and a passenger's seat. Foam (i.e., urethane foam) is filled in the crash pad to protect passenger by absorbing impact when the vehicle collides with an object in an accident. The crash pad includes a core and skin with the foam between the core and the skin. When manufacturing the crash pad, the skin is set on a lower foam mold, the core is set on an upper mold, and a foam liquid (i.e., urethane) is injected between the core and the skin while the upper mold is opened or the upper mold and the lower mold are closed to foam-mold the foam.

Typical manufacturing methods of the crash pad include a foam layer that is thicker according to a mold angle of a core injection product. As a result, the crash pad lacks stiffness especially when a consumer presses the vicinities of the skin and a center fascia. More importantly, when an external force is applied (i.e., an upswing or a down swing), the skin and the foam are easily separate (i.e., a layer separation phenomenon occurs).

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a stiffener for insert-molding that can improve the durability of crash pad by insert-molding a stiffener and facilitate a molding operation by restricting a position of the stiffener at the time of insert-molding the stiffener, and a manufacturing method of a crash pad using the same.

Additional aspects will be set forth in the detailed description which follows, and, in part, will be apparent from the disclosure, or may be learned by practice of the inventive concept.

An exemplary embodiment discloses a stiffener for insert-molding including a stiffening bar for insert-molding and insert setting members provided on an outer periphery of the stiffening bar at a predetermined interval.

An exemplary embodiment also discloses a method of manufacturing a crash pad, including setting a skin on a lower mold, setting a stiffener that matches a skin corner at the skin corner while the skin is set on the lower mold, and injecting a foam liquid between the skin set on the lower mold and a core set on an upper mold while the stiffener is set at the skin corner.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a configuration diagram of a stiffener according to an exemplary embodiment.

FIG. 2 is a diagram illustrating a state in which the stiffener of FIG. 1 is insert-molded.

FIG. 3 is a diagram illustrating a lower mold in which a magnet is insert-molded according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the spacing, size, and relative sizes of elements, regions, etc., may be exaggerated for clarity and descriptive purposes. Also, like reference numerals denote like elements.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

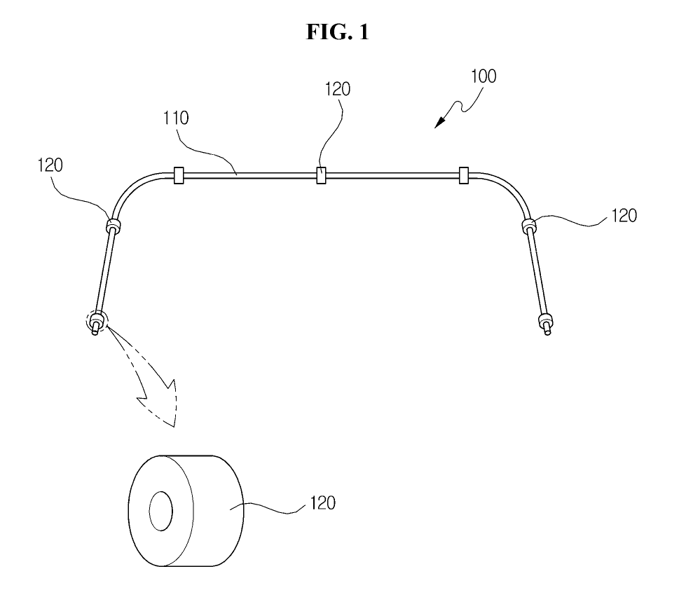

FIG. 1 is a configuration diagram of a stiffener according to an exemplary embodiment. As illustrated in FIG. 1, an insert-molding stiffener 100 according to an exemplary embodiment includes a stiffening bar 110 insert-molded to serve as a frame and insert setting members 120 provided on an outer periphery of the stiffening bar 110.

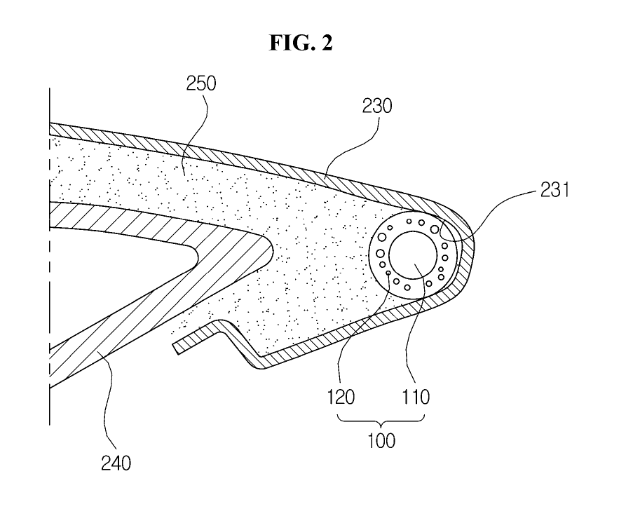

In detail, the stiffening bar 110 may be formed in a bent shape that is deployed at a skin corner 231 of a crash pad in the insert-molding (shown in FIG. 2). The stiffening bar 110 may configure the frame to significantly improve the durability of the crash pad in the insert-molding. The stiffening bar 110 is not limited in shape. For example, the stiffening bar 110 may have various shapes including a circular shape, a quadrangular shape, and an oval shape. The stiffening bar 110 may be a steel circular bar having a diameter of 4 mm. However, the stiffening bar 110 may include any type of material, any diameter size, and any shape.

The insert setting members 120 may be provided on the outer periphery of the stiffening bar 110 at predetermined intervals. The insert setting members 120 may fit in the outer periphery of the stiffening bar 110. The insert setting members 120 may be molded integrally with the outer periphery of the stiffening bar 110.

The insert setting members 120 may have a shape that matches the skin corner 231 so as to be strongly and closely coupled to the skin corner 231 (shown in FIG. 2). Further, since the insert setting members 120 may be insert-molded in foam 250 formed between skin 230 and a core 240 (shown in FIG. 2), the insert setting members 120 may be polycarbonate (PC) foam which may be the same as the foam 250 (shown in FIG. 2). The insert setting members 120 may be positioned at a start portion, an end portion, and corner portions of the outer periphery of the stiffening bar 110 as illustrated in FIG. 1. One insert setting member 120 may be provided every 80 mm on the outer periphery of the stiffening bar 110.

The foam 250 may include polyurethane (PU).

The insert setting members 120 may include at least one of acrylonitrile butadiene styrene (ABS), polycarbonate (PC), an ABS based material, and a polyurethane (PU). Using the PC based material and the ABS based material as the materials of the insert setting members 120 may facilitate adhesion in urethane foaming. Insert setting members 120 are not limited to specific materials and may adopt any injection molding material.

Next, a manufacturing method of the crash pad using the stiffener for insert-molding will be described.

FIG. 2 is a diagram illustrating a state in which the stiffener of FIG. 1 is insert-molded. As illustrated in FIG. 2, a manufacturing method of the crash pad using the stiffener for insert-molding according to an exemplary embodiment includes setting skin 230 on a lower mold 210, setting the stiffener 100 illustrated in FIG. 1 at a skin corner 231, and molding foam 250 by injecting a foam liquid between the skin 230 and a core 240 set on a mold.

More specifically, at the time of setting the skin 230 and the core 240 on the mold, the skin 230 is first set on the lower mold 210 (not shown). Next, the core 240 may be set on an upper mold (not shown) facing the lower mold 210 (not shown). Alternatively, the core 240 is first set on the upper mold followed by the skin set on the opposite lower mold 210.

While the skin 230 and the core 240 are set, the stiffener 100 of FIG. 1 is set at the skin corner 231. Since the insert setting members 120 are closely set at the skin corner 231 at the time of setting the stiffener 100, the stiffener 100 may be set smoothly. Further, since the materials of the insert setting members 120 are the same as that of the foam 250, the insert-molding may be easily achieved.

Since the stiffener 100 set at the skin corner 231 is the same as that of FIG. 1, a detailed configuration description of the stiffener 100 will be omitted. The insert setting members 120 provided on the outer periphery of the stiffening bar 110 may have inner diameters in the range of 3.5 to 3.8 mm. However, the inner diameters of the insert setting members are not limited to 3.8 mm and may include any diameter size.

Both close foaming and open foaming are available at the time of injecting the foam liquid between the skin 230 and the core 240 set on the mold for the foam molding of the foam 250. In the close foaming, the foam liquid is injected while the upper mold and the lower mold are closed. In the open foaming, the foam liquid is injected while the upper mold is opened.

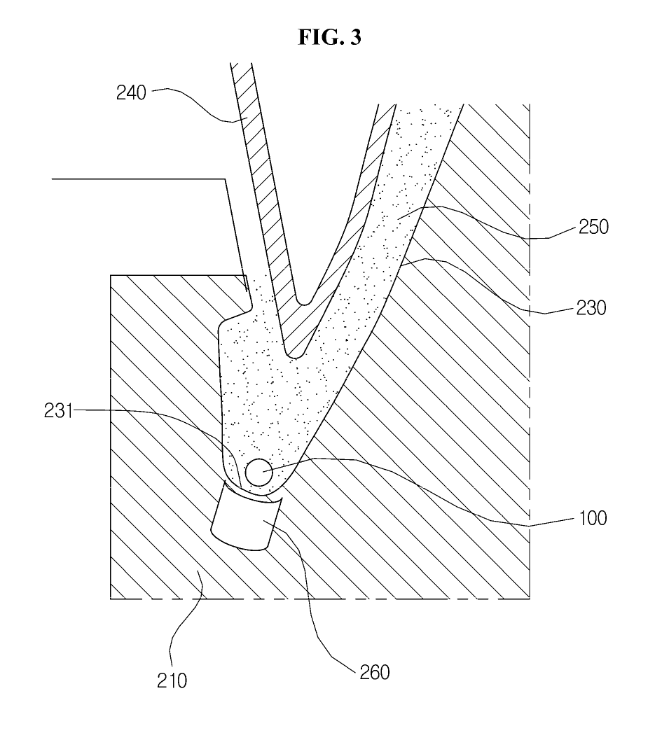

FIG. 3 is a diagram illustrating a lower mold in which a magnet is insert-molded according to an exemplary embodiment. As illustrated in FIG. 3, in the manufacturing method of the crash pad using the stiffener for insert-molding according to an exemplary embodiment the stiffener 100 set at the skin corner 231 is configured by a steel bar influenced by magnetic force unlike the stiffener of FIG. 2.

A magnet 260 is insert-molded at a peripheral portion of the skin corner 231 of the lower mold 210. When the magnet is insert-molded in the lower mold 210, a position of the stiffener 100 set at the skin corner 231 may be restricted by the magnetic force of the magnet 260. As a result, a molding operation is simpler. One or a more magnets 260 may be insert-molded in the lower mold 210 at the time of manufacturing the lower mold 210.

According to exemplary embodiments, durability of a crash pad can be significantly improved by insert-molding a stiffener during the manufacturing process of a crash pad.

A molding operation can be facilitated by restricting a position of the stiffener at the time of insert-molding the stiffener.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A stiffener for insert-molding, comprising:
a stiffening bar for insert-molding; and
insert setting members provided on an outer periphery of the stiffening bar at a predetermined interval.

2. The stiffener of claim 1, wherein the stiffening bar is a steel bar deployed at a skin corner.

3. The stiffener of claim 1, wherein the insert setting members are polyurethane (PU) foam.

4. The stiffener of claim 1, wherein the insert setting members include at least one of acrylonitrile butadiene styrene (ABS) and polycarbonate (PC).

5. The stiffener of claim 1, wherein the insert setting members fit in the outer periphery of the stiffening bar.

6. The stiffener of claim 1, wherein the insert setting members are molded integrally with the outer periphery of the stiffening bar.

7. A method of manufacturing a crash pad, comprising:
setting a skin on a lower mold;
setting a stiffener that matches a skin corner at the skin corner while the skin is set on the lower mold; and
injecting a foam liquid between the skin set on the lower mold and a core set on an upper mold while the stiffener is set at the skin corner.

8. The method of claim 7, wherein the stiffener comprises a stiffening bar and insert setting members provided on an outer periphery of the stiffening bar at a predetermined interval.

9. The method of claim 8, wherein the stiffening bar comprises a steel bar.

10. The method of claim 8, wherein the insert setting members comprise polyurethane (PU) foam.

11. The method of claim 8, wherein the insert setting members comprise at least one of acrylonitrile butadiene styrene (ABS) and polycarbonate (PC).

12. The method of claim 8, wherein the insert setting members fit on the outer periphery of the stiffening bar.

13. The method of claim 8, wherein the insert setting members are molded integrally with the outer periphery of the stiffening bar.

14. The method of claim 8, wherein the insert setting members are made of the same material as the foam liquid.

15. The method of claim 9, wherein the stiffener is the steel bar.

16. The method of claim 15, wherein a magnet is insert-molded at a peripheral portion of the skin corner of the lower mold.
